(19) United States
(12) Patent Application Publication
(10) Pub. No.: US 2023/0139041 A1
(43) Pub. Date: May 4, 2023

(54) FLOAT VALVE

(71) Applicant: Numatic International Limited, Camberley, Surrey (GB)

(72) Inventor: Nicholas Putt, Somerset (GB)

(21) Appl. No.: 17/755,968

(22) PCT Filed: Nov. 18, 2020
(86) PCT No.: PCT/GB2020/052932

§ 371 Date: May 12, 2022

(30) Foreign Application Priority Data
Nov. 19, 2019 (GB) 1916830.1

(51) Int. Cl. F16K 31/24; A47L 7/00; A47L 11/40

(52) U.S. Cl. CPC F16K 31/24; A47L 7/0028; A47L 11/4019

(57) ABSTRACT

The present invention relates to the field of floor treatment machines which involve wet treatment of a floor or carpet in which dirty liquid is collected by suction. In one aspect there is provided a float valve assembly for a collection tank in a suction liquid collection device, the assembly comprising: a float constrained in an enclosure which is configured to permit the float to rise in response to a rising liquid level, a closure feature disposed above the float and connected thereto so that as the float rises the closure feature rises from an initial position, wherein a suction port is disposed in the tank vertically spaced apart from the initial position of the closure feature, the suction port being in fluid communication with a suction drive which in use draws air-entrained liquid into the collection tank, the arrangement being such that as liquid fills the tank the liquid acts upon the float to cause the closure feature to travel towards the suction port, and when the closure feature rises sufficiently, the closure feature obturates the suction port, thereby closing the suction port and preventing further air-entrained liquid from entering. The closure feature may be connected to the float by a plunger which is disposed above the float so that the float shunts the plunger to travel in an upwards direction as the float rises.

The present invention relates to the field of floor treatment machines and in particular wet vacuuming machines, wet carpet cleaning machines or wet floor scrubbing machines. These include a vacuum suction drive in fluid communication with a dirty water collection tank via a suction port. The suction port is typically located in an upper region of the dirty water tank. The port is usually provided with a suction shut-off valve which responds to a threshold water level being reached, such as a float valve. The present invention seeks to provide an improved float valve for use in such machines.

Known float valves comprise a hollow plastic ball float disposed in an elongate vertically oriented cylindrical mesh cage. The cage upper end has a collar which engages with a downwardly facing tubular suction port. As the tank approaches a full water level, the ball floats upwards in its cage until it is seated against the end of the suction port, thereby blocking the port and ceasing suction in the chamber defined above the water level. One problem with this arrangement is that the ball shut-off level tends to be too close to the suction port; the shut-off occurs when the water level is less than the ball diameter from the suction port, which may typically be only several centimetres. This issue has been addressed by placing two balls in the cage, one on top of the other, so that double the distance from the suction port is achieved, but this is not a major improvement. The present invention seeks in one aspect to provide an improved float valve which permits a greater separation between water level and suction port when the suction port is shut-off.

Another problem is that sloshing water in the dirty water tank can give false-full shut-off events by the float ball being washed up into engagement with the suction port. Once engaged the ball is kept sucked in place, which requires the user to turn off the suction drive to permit the float ball to drop back down in the cage. This is a particular problem when the dirty water tank is mounted on a walk-behind machine with a generally vertical handle which may be pivoted up/down or side to side during normal operation and use. The present invention therefor seeks in another aspect to reduce or prevent false-full valve shut-offs.

According to one aspect of the invention there is provided a float valve assembly for a collection tank in a suction liquid collection device, the assembly comprising: a float constrained in an enclosure which is configured to permit the float to rise in response to a rising liquid level, a closure feature disposed above the float and connected thereto so that as the float rises the closure feature rises from an initial position, wherein a suction port is disposed in the tank vertically spaced apart from the initial position of the closure feature, the suction port being in fluid communication with a suction drive which in use draws air-entrained liquid into the collection tank.

The arrangement may be such that as liquid fills the tank the liquid acts upon the float to cause the closure feature to travel towards the suction port, and when the closure feature rises sufficiently, the closure feature obturates the suction port, thereby closing the suction port and preventing further air-entrained liquid from entering.

The closure feature may be connected to the float by a plunger which is disposed above the float so that the float shunts the plunger to travel in an upwards direction as the float rises.

In a preferred aspect of the invention the closure feature may be attached to the plunger by a resilient connector which permits the closure feature to be displaced laterally with respect to a plunger vertical travel direction. The resilient connector may be a flexible rod or conveniently is a spring. The spring may be a coiled spring, preferably an elongate coiled spring.

The resilient connector may be disposed generally vertically, with lateral displacement corresponding to bending movement of the resilient connector. So the suction port may be laterally offset with respect to the plunger vertical travel direction so that as the plunger travels up the closure feature is laterally displaced towards the suction port by the airflow into the port acting on the closure feature. In this way the closure is actuated not just by travel of the closure feature upwards, but also requires lateral movement towards the suction port. This avoids false shut-offs because an occasional rise of the float due to sloshing water in the tank does not necessarily cause the suction port to be shut off. Only if the suction induced airflow is also enough to cause the closure feature to move laterally does the closure feature move across to abut the suction port and close it. This increased airflow is only present when the tank is properly full so that the low-pressure chamber defined above the water level is small enough to provide a sufficiently increased airflow against the closure feature to displace it towards the suction port.

The suction port may preferably comprise a circular or tubular orifice. The closure feature preferably comprises a spherical surface having a diameter which is larger than the diameter of the tubular orifice. This ensures that the orifice is closed when the spherical surface is seated in the rim of the tubular orifice. The closure feature may comprise a generally spherical ball, preferably a hollow ball.

The plunger may be accommodated in a generally vertically oriented throat feature, which may be defined by a collar or shoulder at the upper region of the enclosure. The plunger may be a sliding fit in the throat feature, so that it can readily slide up and down in the throat with respect to the enclosure. The throat feature may comprise two axially (vertically) spaced apart annular bushes. The plunger may comprise an elongate generally cylindrical member. The plunger may have a stop feature, such as an over-diameter end cap, for preventing excessive vertical travel of the plunger. There are preferably two stop features which provide upper and lower limited to plunger travel. These may be provided by lips or cap feature provided on the plunger.

The float may comprise a hollow shaped shell which provides buoyancy in water. The hollow shaped shell preferably comprises a ball. The float enclosure preferably comprises a cage in which the ball is free to roll upwards with rising liquid. Any configuration of cage may be used, so long as the cage provides lateral constraint for the ball but allowed it to travel vertically (within limits), and provided that water can readily enter the cage. Thus a mesh may be used, or a framework, a series of slots or a perforated sidewall, to name a few examples.

The float is typically not attached to the plunger. The float and plunger may be disposed so that in use the rising float abuts a lower region of the plunger so as to cause the plunger to travel upwards. In an alternative arrangement the float may be fixed to the plunger for travel therewith.

In a further aspect of the invention there is provided a float valve as hereinbefore described which is a self-contained device for fitting in a suction separator tank of floor cleaning machine, in the region of a suction port. In this case the device may be provided with a mounting bracket or flange. This mounting bracket or flange may be provided in the collar region of the enclosure.

In yet another aspect of the invention there is provided a wet vacuuming machine, a wet carpet cleaning machine or a wet floor scrubbing machine which includes a vacuum suction drive in fluid communication with a dirty water collection tank via a suction port located in an upper region of the tank, wherein a float valve as hereinbefore described is provided, mounted in the tank so as to act to close the suction port.

The machine will typically have a suction drive, a floor-facing working tool such as a nozzle, scrubbing brush or another agitator. There may be a clean water reservoir adapted to feed water onto a floor (with detergent) or carpet to effect cleaning. The dirty water may be lifted by airflow induced to flow through a floor-facing nozzle, which entrains the liquid into the airflow. The air-entrained water (and dirt particles) are dumped into the dirty water tank in the low-pressure chamber provided therein. The tank gradually fills with liquid and dirt as the airflow leaves the tank through the suction port. The float valve provides an automatic shut-off for the airflow by interrupting the flow into the suction drive. An auto cut-off may be provided for the suction motor which would otherwise surge with the absence of load on actuation of the shut-off valve.

As described above, the suction port maybe oriented with an opening which generally faces laterally towards the position of the closure feature when the closure feature is at the limit of its upward travel. This is a particularly useful feature in the case of walk-behind floor scrubbing machines in which the dirty water tank is located on an upright handle portion. During use, the handle may be tilted up and down or laterally left and right. A partially full tank may have liquid sloshing around and could cause a premature shut-off as the water level surges from time to time. By requiring a lateral movement of the closure feature, in addition to simple buoyant travel, these false shut-offs can be avoided. This is because although the float may rise vertically, the airflow over the closure feature (e.g. ball) will not necessarily be enough to flex the flexible connection enough to permit the closure feature to block the suction port.

Only when the tank is properly full will the airflow in the low-pressure chamber in the tank provide sufficient pressure to displace the closure feature into the suction port.

Following is a description by way of example only of one mode for putting the invention into effect.

In the drawings:

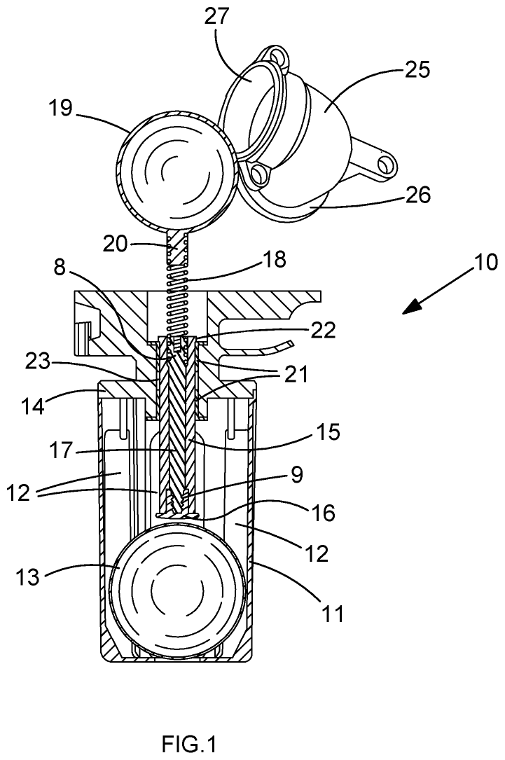

FIG. 1 is a sectional side view of a float valve in accordance with the present invention.

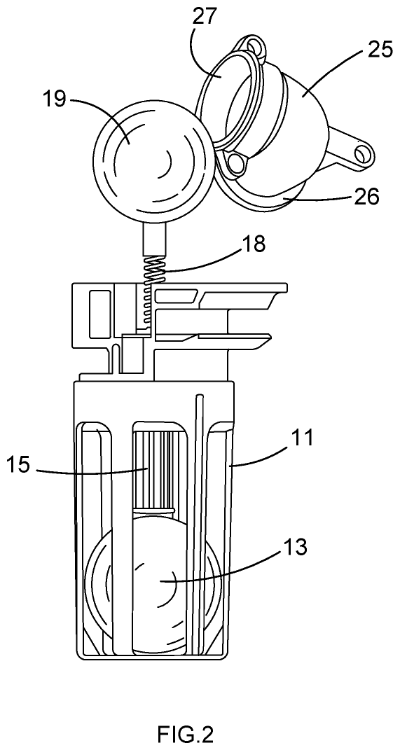

FIG. 2 is a schematic side view of the float valve in an open configuration.

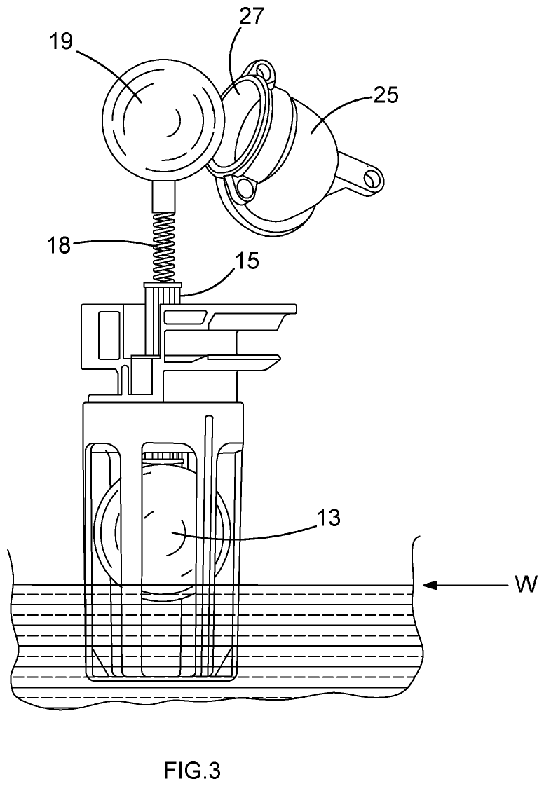

FIG. 3 is a side view of the float valve in an actuator position in which the float has risen due to influx of water.

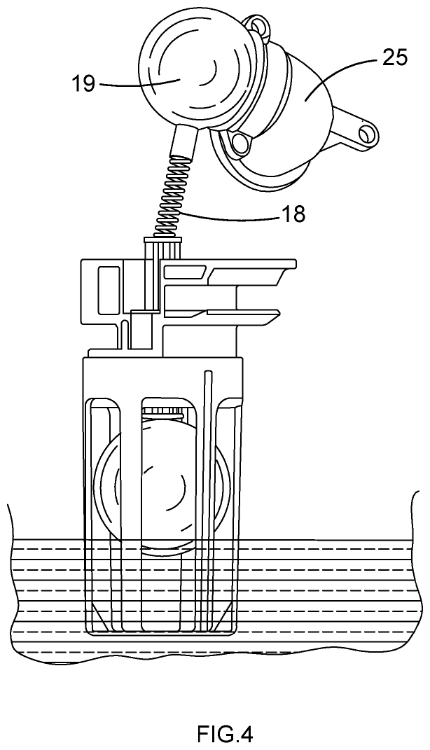

FIG. 4 is a schematic side view of the float in a closed configuration.

In FIG. 1 a float valve in accordance with the present invention is shown generally as 10. At a lower region of the float valve there is provided a generally cup shaped ball cage 11. The ball cage is provided with a plurality of cut outs through the side walls thereof shown as vertical slots 12 in FIG. 1. A lower end of the cage is closed so as to retain a riser ball float 13. Ball 13 is a hollow moulded plastics sphere having a diameter slightly less than the inner diameter of the ball cage. Thus the ball is constrained against any significant lateral motion in the cage, but is able to travel up and down within the cage (subject to any other constraints applied). An upper region of the cage is closed by a generally annular collar 14. The collar is provided with a central bore or throat 23 which accommodates a generally cylindrical elongate plunger assembly 15.

The plunger assembly includes a retaining end cap 16 at a lower end thereof. The end cap has an outer diameter slightly larger than that of the plunger 15. A central bore of the plunger is occupied by a spring locking pin 17. A lower end of the spring locking pin is retained by a screw threaded connection 9 made with a threaded bore in the retaining end cap 16. An upper end 8 of the spring locking pin 17 has a screw thread which retains a lower end of a coiled spring 18. An upper end region of the coiled spring is threaded onto a depending post 20 of a spherical, hollow closure ball 19.

In the axial bore of the collar 14 there are provided upper and lower sleeve bushes 21, each with an annular flange. These sleeve bushes are sized so as to facilitate sliding axial travel of the plunger 15 in the bore 23. Thus the plunger may move freely up and down. The extent of upward motion is limited by the abutment of the end cap 16 with the lower bush. An upper end region of the plunger is provided with an annular lip 22 which limits downward travel of the plunger by abutment with the upper bush 21.

In a typical application, the float valve is mounted in a dirty water collection tank (not shown) of a vacuum suction separator for removing water from an incoming airflow.

The airflow is typically lifted from a wet floor surface and comprises dirt and dirty water lifted during a cleaning process from a floor surface. As the liquid enters the low-pressure chamber represented by the dirty water tank, its velocity decreases rapidly and the water particles are then deposited in the tank. Over time the deposited liquid begins to fill the tank. The air drawn into the tank continues towards the suction drive motor via a suction separator port 25 shown in FIG. 1. The separator port is attached to an inner wall of the dirty water tank and communicates with the suction motor drive. As is best shown in FIG. 3, the separator port comprises an L form right angle tubular member with a base flange 26. An inlet orifice 27 is directed laterally towards the closure ball 19, with a slight incline upwards. The orifice 27 has a diameter which is slightly less than the diameter of the closure ball 19.

In FIG. 2 the float valve of FIG. 1 is shown in the fully open position. The riser ball 13 is resting on the bottom of the cage and the plunger 15 is resting on top of the riser ball. The closure ball 19 is standing up on the end of the vertical coil spring 18. In FIG. 3 a body of water has entered the tank and reached the level indicated by the arrow W. The buoyant raiser ball 13 has risen with the water level and has pushed the plunger 15 upwards. The coiled spring 18 and closure ball have correspondingly traveled upwards and the ball 19 is now at the same vertical level as the orifice 27 of the separator port 25. In FIG. 4 the ball 19 has traveled laterally so as to become seated in the circular orifice 27. The coil spring 18 has flexed to allow this lateral movement. The lateral movement is induced by the acceleration of the airflow around the ball as it passes the float and enters the orifice 27. The suction drive maintains the valve in a closed position by continuing to draw the ball 19 intimately against the orifice lip 27.

For the user of a floor cleaning machine the operation of the valve is automatic and closure indicates that the dirty water tank is full. The vacuum drive may then be turned off (or be subject to an auto-cut off) and the tank may be taken for emptying. As soon as the vacuum drive has been turned off the ball will retreat back laterally to the vertical orientation shown in FIG. 3, opening the suction port irrespective of the water level in the tank, or in fact of the orientation of the tank. Once the liquid is being emptied the water level W reduces and the riser ball 13 descends back to the bottom of the cage as shown in FIG. 2.

In summary, the present invention relates to the field of floor treatment machines which involve wet treatment of a floor or carpet and suction collection of dirty liquid. In one aspect there is provided a float valve assembly for a collection tank in a suction liquid collection device, the assembly comprising: a float constrained in an enclosure which is configured to permit the float to rise in response to a rising liquid level, a plunger which is disposed above the float so as to travel in an upwards direction when the float rises, a closure feature projecting upwards from an upper end region of the plunger so as to travel upwards with the plunger, wherein a suction port is disposed in the tank vertically spaced apart from the closure feature, the suction port being in fluid communication with a suction drive which in use draws air-entrained liquid into the collection tank, the arrangement being such that as liquid fills the tank the liquid acts upon the float to cause the closure feature to travel towards the suction port, and when the closure feature rises sufficiently, the closure feature obturates the suction port, thereby closing the suction port and preventing further air-entrained liquid from entering. The closure feature may be attached to the plunger by a resilient connector which permits the closure feature to be displaced laterally with respect to a plunger vertical travel direction.

1. A float valve assembly for a collection tank in a suction liquid collection device, the assembly comprising:
a float constrained in an enclosure which is configured to permit the float to rise in response to a rising liquid level,
a closure feature disposed above the float and connected thereto so that as the float rises the closure feature rises from an initial position,
wherein a suction port is disposed in the tank vertically spaced apart from the initial position of the closure feature, the suction port being in fluid communication with a suction drive which in use draws air-entrained liquid into the collection tank,
the arrangement being such that as liquid fills the tank the liquid acts upon the float to cause the closure feature to travel towards the suction port, and when the closure feature rises sufficiently, the closure feature obturates the suction port, thereby closing the suction port and preventing further air-entrained liquid from entering.

2. A float valve assembly as claimed in claim 1 wherein the closure feature is connected to the float by a plunger which is disposed above the float so that the float shunts the plunger to travel in an upwards direction as the float rises.

3. A float valve assembly as claimed in claim 2 wherein the closure feature is attached to the plunger by a resilient connector which permits the closure feature to be displaced laterally with respect to a plunger vertical travel direction.

4. A float valve assembly as claimed in claim 3 wherein the resilient connector comprises a spring.

5. A float valve assembly as claimed in claim 3 wherein the suction port is laterally offset with respect to the plunger vertical travel direction so that as the plunger travels up the closure feature can be laterally displaced on the resilient connector towards the suction port by the airflow into the port.

6. A float valve assembly as claimed in claim 1 wherein the suction port comprises a circular or tubular orifice.

7. A float valve assembly as claimed in claim 6 wherein the closure feature comprises a spherical surface having a diameter which is larger than the diameter of the tubular or circular orifice, so that the orifice is closed when the spherical surface is seated in the tubular orifice.

8. A float valve assembly as claimed in claim 1 wherein the closure feature comprises a generally spherical ball.

9. A float valve assembly as claimed in claim 2 wherein the plunger is accommodated in a generally vertically oriented throat feature.

10. A float valve assembly as claimed in claim 9 wherein the plunger is a sliding fit in the throat feature.

11. A float valve assembly as claimed in claim 9 wherein the throat feature comprises two axially spaced apart annular bushes.

12. A float valve assembly as claimed in claim 2 wherein the plunger comprises an elongate generally cylindrical member.

13. A float valve assembly as claimed in claim 12 wherein the plunger has a stop feature, such as an over-diameter end cap, for preventing excessive vertical travel of the plunger.

14. A float valve assembly as claimed in claim 1 wherein the float comprises a hollow, shaped shell.

15. A float valve assembly as claimed in claim 14 wherein the hollow shaped shell comprises a ball.

16. A float valve assembly as claimed in claim 15 wherein the float enclosure comprises a cage in which the ball is free to float or roll upwards with rising liquid.

17. A float valve assembly as claimed in claim 2 wherein the float is not attached to the plunger and the float and plunger are disposed so that in use the rising float abuts a lower region of the plunger so as to cause the plunger to travel upwards.

18. A float valve assembly as claimed in claim 2 wherein the float is fixed to the plunger for travel therewith.

19. A float valve assembly as claimed in claim 1 which is a self-contained device for fitting in a suction separator tank of a floor cleaning machine in the region of the suction port of the floor cleaning machine.

20. A wet vacuuming machine, a wet carpet cleaning machine or a wet floor scrubbing machine which includes a vacuum suction drive in fluid communication with a dirty water collection tank via a suction port located in an upper region of the tank, wherein a float valve assembly is mounted in the tank so as to act to permit closure of the suction port when the tank is full,
wherein the float valve assembly comprises:
a float constrained in an enclosure which is configured to permit the float to rise in response to a rising liquid level in the tank,
a closure feature disposed above the float and connected thereto so that as the float rises the closure feature rises from an initial position,
wherein the suction port is disposed in the dirty water collection tank vertically spaced apart from the initial position of the closure feature, the suction port being in fluid communication with the suction drive which in use draws air-entrained liquid into the collection tank,
the arrangement being such that as liquid fills the dirty water collection tank the liquid acts upon the float to cause the closure feature to travel towards the suction port, and when the closure feature has risen sufficiently, the closure feature obturates the suction port, thereby closing the suction port and preventing further air-entrained liquid from entering the port.

21. The machine of claim 20 wherein the suction port is oriented with an opening which generally faces laterally towards the position of the closure feature when the closure feature is at the limit of its upward travel.
